(19) United States
(12) Patent Application Publication
(10) Pub. No.: US 2011/0141253 A1
(43) Pub. Date: Jun. 16, 2011

(54) REMOTE INTERACTIVE MONITORING AND ALARM SYSTEM UTILIZING TELEVISION APPARATUS WITH VIDEO-SONG ACCOMPANIMENT FUNCTION

(75) Inventor: Steven TSAI, Taoyuan County (TW)

(73) Assignee: HERAN CO., LTD., Gui-shan Township (TW)

(21) Appl. No.: 12/639,341

(22) Filed: Dec. 16, 2009

(51) Int. Cl. H04N 7/18; H04M 3/42

(52) U.S. Cl. 348/61; 455/414.1; 348/734; 340/691.6; 345/1.3; 348/E07.085; 375/240.01

(57) ABSTRACT

A remote interactive monitoring and alarm system utilizing a television apparatus with a video-song accompaniment function is provided. The remote interactive monitoring and alarm system is composed of a television apparatus, at least one monitor, at least one transmission unit, at least one broadcasting unit, an alarm triggering unit and at least one remote control unit. The television apparatus is further composed of a video/audio encoder, a karaoke function control circuit and a transmission interface. The karaoke function control circuit provides a control of the video-song accompaniment function, the transmission interface is configured to receive an insertion of a external storage device which is used to store the video-song data, and the external storage device can be detached and connected to a computer for downloading the video-song data.

### BACKGROUND OF THE INVENTION

1. Field of the Invention

The present invention is related to a remote interactive monitoring and alarm system, and more particular to a remote interactive monitoring and alarm system utilizing a television apparatus which equipped with a video-song accompaniment function that is suitable to be set in homes, companies, stores, and etc.

2. Description of Related Art

With the reference to FIG. 1 which is a schematic view illustrating a monitoring and alarm system according to a prior art, the monitoring and alarm system is composed of a control center 1, at least one monitor 2 and an alarm 3. The control center 1 is connected to the monitor 2 and the alarm 3, and a display screen 4 is set in the control center 1. The monitoring and alarm system achieves the monitoring function and enhances the safety by monitoring the video data that shown on the display screen 4 of the control center 1; in addition, the video data is obtained from the monitors 2 to activate the alarm 3 to generate an alarm sound. Although the prior monitoring and alarm system can achieve basic monitoring safety, the monitor can be only performed the monitoring function passively. Besides, it requires enormous construction fees to set up the control center 1. Furthermore, users themselves can not understand the real-time status of the monitored environment and can not interact therewith. Therefore, the prior monitoring and alarm system can not exactly satisfy users' requirements.

As the attention paid to entertainments that has been growing up, singing becomes a popular activity for many people. Besides going to a karaoke box establishment or a karaoke shop for singing with close friends, it is popular to set a karaoke machine at home so as to sing with family and friends. In general, a conventional karaoke machine is connected to a television apparatus by transmission wires; therefore, the video/audio signals generated by the karaoke machine that can then be transmitted to the screen and the speaker of the television apparatus to broadcasting. The karaoke machine contains a hard disc with a huge storage volume for storing a large number of video-song data. Users can choose the desirable songs by looking up the songbook or operating the karaoke-on-demand system. Even though there are numerous songs, including Chinese songs, Taiwanese songs, Cantonese songs, Japanese songs, English songs, children's songs, and etc., among these songs, users usually focus on several specific songs that they really like and want to sing. Sometimes, users' requested songs are not stored in the karaoke machine. Besides, every time when new songs are produced, it is necessary to store these new songs into the hard disc. Although the karaoke machine provides a huge volume hard disc for storing numerous songs, there might be only a few songs that users are really interested in. Therefore, for some consumers, the huge volume hard disc which is configured in the karaoke machine for storing numerous video-song data, is not useful and only increases the cost of the machine. Moreover, it is not easy to choose a specific song among the numerous video-song data then.

Among these numerous conventional karaoke songs, most of them are undesirable. The prior karaoke machine with the huge volume hard disc has not only resulted in a difficulty in choosing a specific song but also increased the cost certainly. Obviously, the prior karaoke machine can not satisfy users' requirements. The present invention is disclosed herein to solve the aforementioned disadvantages and problems of the prior art.

### SUMMARY OF THE INVENTION

Accordingly, the primary objective of the present invention is to provide a remote interactive monitoring and alarm system utilizing a television apparatus with a video-song accompaniment function, which is composed of a television apparatus, at least one monitor, at least one transmission unit, at least one broadcasting unit and at least one remote control unit; in addition it enables the at least one remote control unit to monitor the video streaming which is obtained from the at least one monitor and transmitted via the at least one transmission unit actively so as to activate a real-time remote broadcasting interactively. In addition, by means of a mobile phone or a computer which can act as the at least one remote control unit, users can perform real-time monitoring or remote control to interact with the monitoring environment and the public security unit more actively. Furthermore, the present invention can decrease the construction cost and improve the practicability, convenience and safety of operation substantially.

The secondary objective of the present invention is to provide a remote interactive monitoring and alarm system utilizing a television apparatus with a video-song accompaniment function that can increase the using security by providing the at least one broadcasting unit which can be activated to generate an alarm sound to pretend a human being during housebreaking or monitoring the status at home; for example, monitoring the status for elders or children at home, interacting with them, or monitoring the working status of a foreign housekeeper at home, and etc.

The another objective of the present invention is to provide a remote interactive monitoring and alarm system utilizing a television apparatus with a video-song accompaniment function that can increase the residential security by connecting the alarm triggering unit with a public security unit.

The another objective of the present invention is to provide a remote interactive monitoring and alarm system utilizing a television apparatus with a video-song accompaniment function that can enable users to choose desirable songs by providing the external storage device which can be detached and connected to the computer for downloading the video-song data from the local computer or the network. In addition, the karaoke-on-demand system can be updated automatically as the external storage device that is replaced or set by users themselves in accordance with their fondness. According to the present invention, users' setting can be read automatically.

The another objective of the present invention is to provide a remote interactive monitoring and alarm system utilizing a television apparatus with a video-song accompaniment function that can simplify the video-song data, enable users to find a specific song easily and rapidly, decrease the construction cost, save storage space and obtain economic benefit by choosing the external storage device with a proper volume which is used to store users' favorite and desired songs.

The another objective of the present invention is to provide a remote interactive monitoring and alarm system utilizing a television apparatus with a video-song accompaniment function that can display the movie files on the big screen of the television apparatus directly by transmitting the file via the transmission interface (for example, a USB interface). Formerly, the movie files can only be displayed on a computer, or be reproduced to be an optical disc which can then be displayed in a DVD player.

The last objective of the present invention is to provide a remote interactive monitoring and alarm system utilizing a television apparatus with a video-song accompaniment function that can simplify the system structure and operation process and avoid complicated wiring by starting the video-song accompaniment function with the external storage device which is connected to the transmission interface of the television apparatus after downloading the video-song data from a computer.

In order to achieve the foregoing objective, the remote interactive monitoring and alarm system, according to the present invention, is composed of a television apparatus, at least one monitor, at least one transmission unit, at least one broadcasting unit, an alarm triggering unit and at least one remote control unit. The television apparatus contains a video/audio encoder, a karaoke function control circuit and a transmission interface. The karaoke function control circuit provides a control of the video-song accompaniment function, the transmission interface is configured to receive an insertion of a external storage device which is used to store the video-song data, and the external storage device can be detached and connected to a computer for downloading the video-song data. The at least one monitor is connected to the video/audio encoder of the television apparatus either directly or via the transmission interface; one terminal of the at least one transmission unit is connected to the video/audio encoder; the at least one broadcasting unit is connected to the video/audio encoder; the alarm triggering unit is connected to the video/audio encoder; the at least one remote control unit is connected to the other terminal of the at least one transmission unit. Thereby, the video streaming obtained by the at least one monitor that can be transmitted to the at least one remote control unit via the at least one transmission unit, and the at least one remote control unit can monitor the video streaming actively so as to activate a real-time remote broadcasting and interact with the public security unit excellently. In addition, the external storage device equipped in the television apparatus with the video-song accompaniment function that can be connected to a computer for downloading user's chosen video-song data. The present invention can increase the practicability, convenience and safety substantially.

### BRIEF DESCRIPTION OF THE DRAWINGS

The present invention can be fully understood from the following detailed description and preferred embodiment with reference to the accompanying drawings, in which:

FIG. 1 is a schematic view illustrating a monitoring and alarm system according to a prior art;

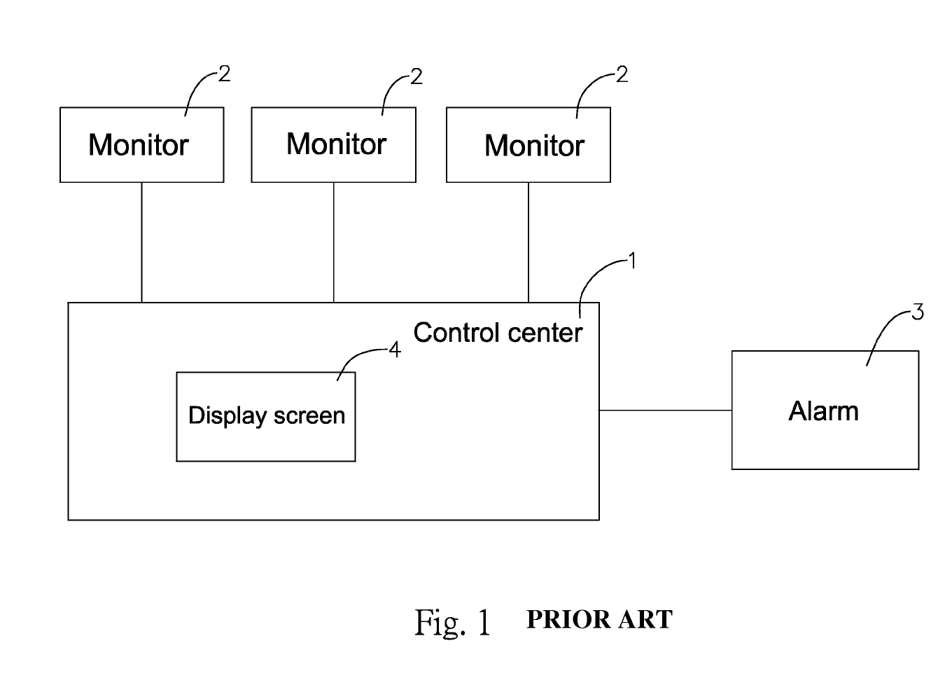

FIG. 2 illustrates a system structure under operation of the first embodiment according to the present invention;

FIG. 3 illustrates a system structure showing a external storage device is connected to a computer for downloading video-song data of the first embodiment according to the present invention;

FIG. 4 is a schematic view of the first embodiment according to the present invention; and

FIG. 5 is a schematic view of the second embodiment according to the present invention.

### DETAILED DESCRIPTION OF THE PREFERRED EMBODIMENTS

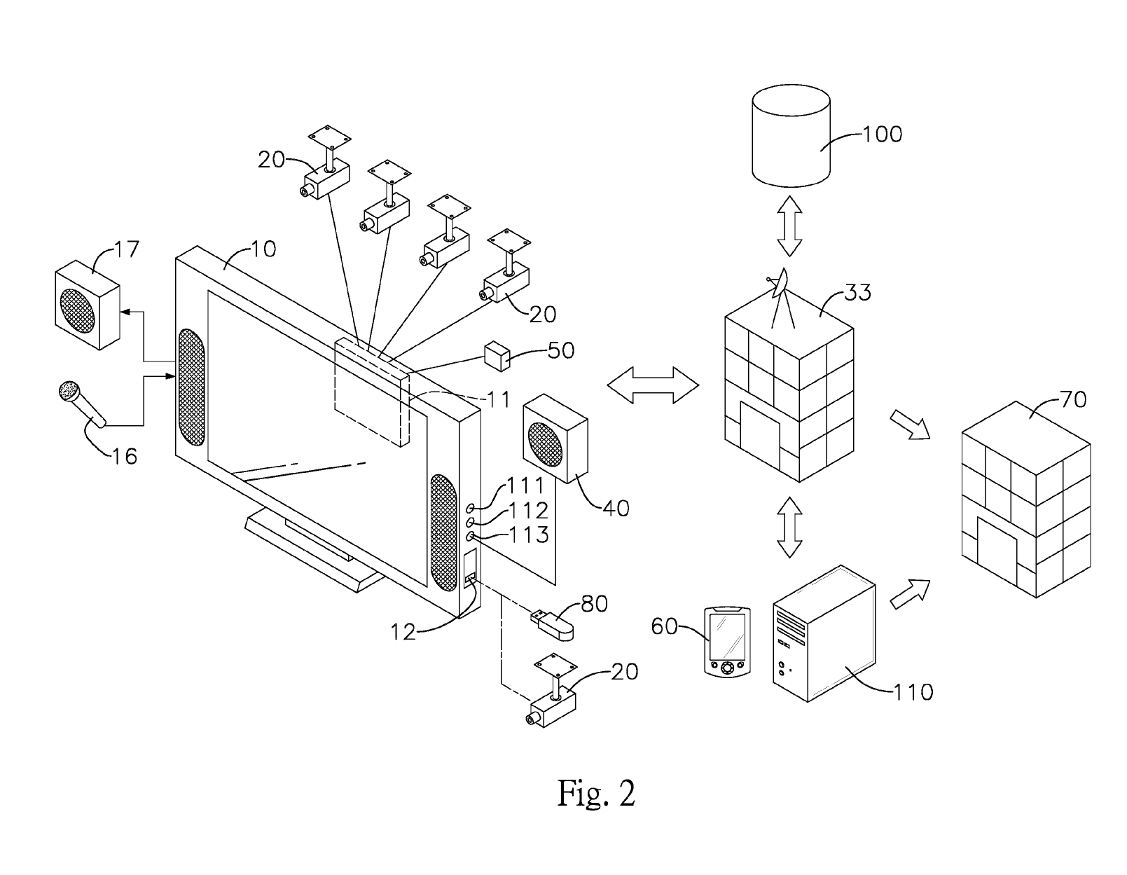

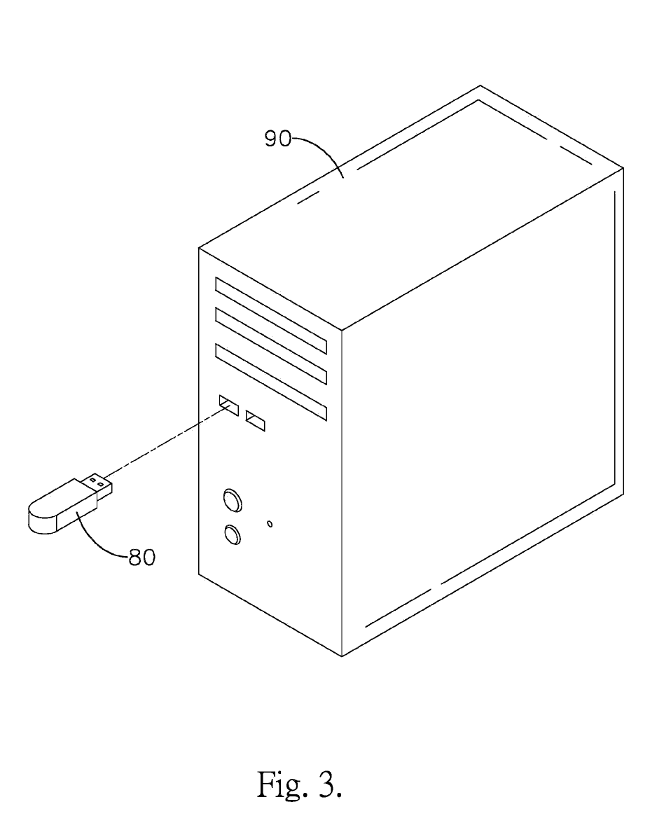

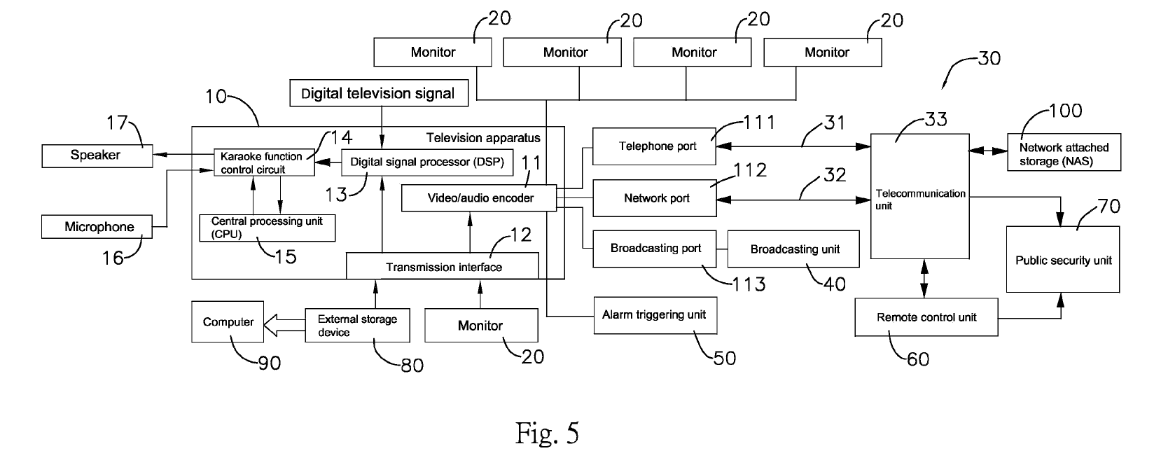

Please refer to FIG. 2 to FIG. 5. The present invention provides a remote interactive monitoring and alarm system utilizing a television apparatus with a video-song accompaniment function (karaoke function). The remote interactive monitoring and alarm system includes a television apparatus 10 which is equipped with a video-song accompaniment function, at least one monitor 20, at least one transmission unit 30, at least one broadcasting unit 40, an alarm triggering unit 50 and at least one remote control unit 60.

The television apparatus 10 is equipped with a video/audio encoder 11, a karaoke function control circuit 14 and a transmission interface 12. The video/audio encoder 11 is equipped with a telephone port 111, a network port 112 and at least one broadcasting port 113. The karaoke function control circuit 14 provides a control of the video-song accompaniment function. The transmission interface 12 (ex: USB-universal serial bus) is configured to connect an external storage device 80. The external storage device 80 is used to store the video-song data. The external storage device 80 can be detached from the transmission interface 12 and connected to a computer 90 for downloading the video-song data.

The at least one monitor 20 is connected to the video/audio encoder 11 of the television apparatus 10. Additionally, the at least one monitor 20 can be connected to the video/audio encoder 11 of the television apparatus 10 either directly or via the transmission interface 12.

One terminal of the at least one transmission unit 30 is connected to the video/audio encoder11, and the other terminal of the at least one transmission unit 30 is connected to a network attached storage (NAS) 100.

The at least one broadcasting unit 40 is connected to the video/audio encoder 11. In one embodiment, the at least one broadcasting unit 40 is a speaker.

The alarm triggering unit 50 is connected to the video/audio encoder 11.

The at least one remote control unit 60 is connected to one terminal of the at least one transmission unit 30. The at least one remote control unit 60 can be a mobile phone or a computer in practice.

Besides, the telephone port 111 and the network port 112 are respectively connected to the corresponding transmission units 30, and the at least one broadcasting port 113 is connected to the at least one broadcasting unit 40 correspondingly. In one embodiment, the at least one transmission unit 30 or the at least one remote control unit 60 is further connected to a public security unit 70. In another embodiment, the at least one transmission unit 30 and the at least one remote control unit 60 are further connected to a public security unit 70 together. The transmission unit 30 can adopt or use a telephone wire 31 or a network cable 32 for connecting the at least one remote control unit 60. In addition, the at least one transmission unit 30 belongs to a telecommunication unit 33 which can transmit a video streaming obtained by the at least one monitor 20 to a network attached storage (NAS) 100 in real-time.

Moreover, the external storage device is portable so as to be connected to the computer 90 for downloading the video-song data rapidly and conveniently. In the embodiment illustrated in the figures, the transmission interface 12 is an universal serial bus (USB) interface, and the external storage device 80 is a USB stick. The USB stick can be detached from the transmission interface 12 and connected to the USB port of the computer 90 for downloading the video-song data, including the music files, caption files or video files. Afterwards, the USB stick can be connected back to the USB interface of the television apparatus 10, and users can start to enjoy karaoke function by choosing a specific song with a remote control or the function keys. In addition, after being attached onto the television apparatus 10, the external storage device 80 can be either extended out of the television apparatus 10 or hidden therein. The television apparatus 10 can be a liquid crystal display (LCD) television or a plasma display panel (PDP) television.

In another embodiment, a memory card adapter can be configured in the transmission interface 12, and the external storage device 80 can be a memory card. After coupling the memory card to the computer for downloading desirable video-song data, the memory card can be coupled to the television apparatus 10 so as to be read by the karaoke function.

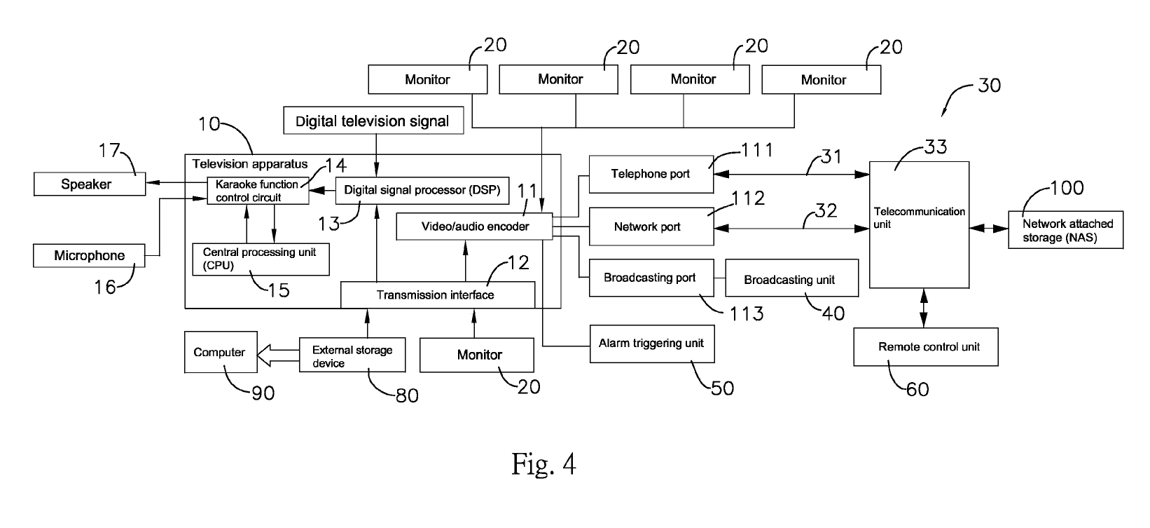

Please refer to FIG. 4 which is a schematic view of the preferred embodiment according to the present invention. The present invention is built up by the television apparatus 10 which is connected to the external storage device 80 via the transmission interface 80 for transmitting the video-song data. The transmission interface 12 is connected to a digital signal processor (DSP) 13 which is used to convert the music files, video files and caption files stored in the external storage device into video/audio signals. The karaoke function control circuit 14 is connected to the digital signal processor 13 for controlling all the karaoke functions. A central processing unit (CPU) 15 is connected to the karaoke function control circuit 14 for controlling the inner circuit. The karaoke function control unit 14 includes a voice input port which is connected to a microphone 16, and an audio output port which is connected to a speaker 17. The karaoke function control unit 14 processes the vocal signals received by the microphone 16, reproduces the vocal signals by remixing with music signals and further outputs the reproduced signals by the speaker 17.

The television apparatus 10 can be connected to an antenna for receiving wireless signals of a digital television program. The received digital television signals are processed and converted by the digital signal processor 13 and further transmitted to the karaoke function control circuit 14 so that user can hold the microphone and sing with a TV show.

User can attach the external storage device 80 onto the computer 90 for downloading the interesting songs and then remove the storage device 80 onto the transmission interface 12 of the television apparatus 10. Following, the video-song function can be activated by operating the function keys or the remote control. The construction of the apparatus is simple and the operation is easy.

Therefore, through the embodiment illustrated above and FIG. 2 to FIG. 5, the feature of the remote interactive monitoring and alarm system utilizing a television apparatus with a video-song accompaniment function of the present invention consists in the composition of the television apparatus 10, the at least one monitor 20, the at least one transmission unit 30, the at least one broadcasting unit 40, the alarm triggering unit 50 and the at least one remote control unit 60. Thereby, the at least one remote control unit 60 can monitor the video streaming which is obtained by the at least one monitor 20 and transmitted via the at least one transmission unit 30 and activate a real-time remote broadcasting interactively so that users can perform active monitoring and interacting with the monitoring environment and the public security unit more actively. Besides, the present invention can decrease the construction cost and improve the practicability, convenience and safety of operation substantially. In addition, the present invention can increase the security of using by providing the at least one broadcasting unit 40 which can be activated to generate an alarm voice so as to pretend a human being during housebreaking or monitoring the status at home, for example, monitoring the status of the elder or the children at home, interacting with them, or monitoring the working status of a foreign housekeeper at home, and etc. Moreover, the present invention can increase the security of the residence by connecting the television apparatus 10, the alarm triggering unit 50 and the public security unit 70. Furthermore, the present invention integrates the karaoke function circuit 14 inside the television apparatus 10 and provides the external storage device 80 which can be detached and connected to the computer 90 for downloading the desirable video-song data. The necessary storage space of the external storage device 80 is flexible and can be chosen according to a proper storage volume so that the present invention is with lower construction cost. In conclusion, the present invention can increase the practicability, convenience and safety substantially.

What is claimed is:

1. A remote interactive monitoring and alarm system comprises:
a television apparatus with a video-song accompaniment function, the said television apparatus comprises a video/audio encoder, a karaoke function control circuit and a transmission interface, where the said karaoke function control circuit provides a control of the video-song accompaniment function, and the said transmission interface has been configured to receive an insertion of a external storage device which is used to store a plurality of video-song data; in addition, this said external storage device is able to be detached and further connected to a computer for downloading the video-song data;
at least one monitor which has mutually coupled with the said video/audio encoder of the said television apparatus;
at least one transmission unit which one end is mutually connected with the said video/audio encoder;
at least one broadcasting unit which is mutually connected with the said video/audio encoder;
an alarm triggering unit which has mutually coupled with the said video/audio encoder; and
at least one remote control unit which has mutually connected with the other terminal of the said at least one transmission unit.

2. The remote interactive monitoring and alarm system according to claim 1, wherein the said video/audio encoder of the said television apparatus comprises a telephone port, a network port and at least one broadcasting port, each of the said telephone port and the said network port is connected to the said transmission unit correspondingly, and the said at least one broadcasting port is connected to the said at least one broadcasting unit.

3. The remote interactive monitoring and alarm system according to claim 1, wherein the said at least one transmission unit and the said at least one remote control unit are further connected to a public security unit.

4. The remote interactive monitoring and alarm system according to claim 1, wherein the said transmission unit comprises a telephone wire which connects the said video/audio encoder, a telecommunication unit and the said at least one remote control unit.

5. The remote interactive monitoring and alarm system according to claim 2, wherein the said transmission unit comprises a telephone wire which connects the said video/audio encoder, a telecommunication unit and the said at least one remote control unit.

6. The remote interactive monitoring and alarm system according to claim 3, wherein the said transmission unit comprises a telephone wire which connects the said video/audio encoder, a telecommunication unit and the said at least one remote control unit.

7. The remote interactive monitoring and alarm system according to claim 1, wherein the said transmission unit comprises a network cable which connects said video/audio encoder, a telecommunication unit and the said at least one remote control unit.

8. The remote interactive monitoring and alarm system according to claim 2, wherein the said transmission unit comprises a network cable which connects said video/audio encoder, a telecommunication unit and the said at least one remote control unit.

9. The remote interactive monitoring and alarm system according to claim 3, wherein the said transmission unit comprises a network cable which connects said video/audio encoder, a telecommunication unit and the said at least one remote control unit.

10. The remote interactive monitoring and alarm system according to claim 1, wherein the said at least one broadcasting unit is a speaker.

11. The remote interactive monitoring and alarm system according to claim 2, wherein the said at least one broadcasting unit is a speaker.

12. The remote interactive monitoring and alarm system according to claim 1, wherein the said at least one remote control unit is a mobile phone.

13. The remote interactive monitoring and alarm system according to claim 3, wherein the said at least one remote control unit is a mobile phone.

14. The remote interactive monitoring and alarm system according to claim 1, wherein the said at least one remote control unit is a computer.

15. The remote interactive monitoring and alarm system according to claim 3, wherein the said at least one remote control unit is a computer.

16. The remote interactive monitoring and alarm system according to claim 1, wherein the said external storage device is connected to a digital signal processor (DSP) via the said transmission interface, the digital signal processor is capable of converting the music files, video files and caption files that stored inside the said external storage device into video/audio signals, the digital signal processor is connected to the said karaoke function control circuit, and the said karaoke function circuit is connected to a central processing unit (CPU).

17. The remote interactive monitoring and alarm system according to claim 9, wherein the digital signal processor further processes and converts the digital television signals.

18. The remote interactive monitoring and alarm system according to claim 1, wherein the said transmission interface is a universal serial bus (USB) interface.

19. The remote interactive monitoring and alarm system according to claim 11, wherein the said at least one monitor is connected to the said video/audio encoder via the universal serial bus interface.

20. The remote interactive monitoring and alarm system according to claim 1, wherein the said transmission interface is a memory card adapter and the said external storage device is a memory card.
